(19) United States
(12) Patent Application Publication
(10) Pub. No.: US 2007/0144839 A1
(43) Pub. Date: Jun. 28, 2007

(54) INTEGRATED BRAKE, SUSPENSION AND WHEEL SYSTEM

(76) Inventors: Dinesh C. Seksaria, Novi, MI (US); Roger Kaufold, Pittsburgh, PA (US); Thomas J. Murphy, Jeannette, PA (US); Richard A. Sokol, Harrison City, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/610,683

(22) Filed: Dec. 14, 2006

Related U.S. Application Data
(63) Continuation-in-part of application No. 11/300,241, filed on Dec. 14, 2005.

(51) Int. Cl. F16D 51/00

(52) U.S. Cl. 188/218 R; 188/78; 188/76

(57) ABSTRACT

A brake system including a suspension component housing at least one actuation piston to reversibly extend a brake pad; and a wheel that is in rotational engagement to the suspension component, the wheel having a rim portion with an interior surface that is contacted by the brake pad of at least one actuation piston when in an extended position.

### CROSS REFERENCE TO RELATED APPLICATIONS

The present invention is a continuation in part and claims the benefit of U.S. Pat. Application Ser. No. 11/300,241, filed Dec. 14, 2005, the whole contents and disclosure of which is incorporated by reference as is fully set forth herein.

### FIELD OF THE INVENTION

The present invention relates to brake systems. In one embodiment, the present invention relates to brake systems for automotive applications.

### BACKGROUND OF THE INVENTION

Many different types of vehicle brake systems have evolved over the last 100 years ranging from pure mechanical devices to more sophisticated systems incorporating hydraulic and/or electromagnetic principals to brake or assist in braking the vehicle.

In all cases the kinetic energy of the moving vehicle must be absorbed by the braking system, wherein the kinetic energy is typically absorbed by being converted into heat. Modern vehicles are of significant mass and travel at significant speeds, hence producing a large amount of kinetic energy that must be dissipated quickly by conversion to heat in the brake system with minimal effort by the driver. Typically, this is accomplished in today's cars by hydraulically assisted brake pads (pucks) frictionally contacting brake disks (rotors) or drums.

Additionally, braking may be assisted by multi-brake pad (puck) independently controlled antilock braking. Although, these systems increase the safety and handling quality of the vehicle, the systems also increase the vehicle's weight, complexity and cost. By increasing the mass of the brake system the vehicles kinetic energy is increased at speed, wherein the increased mass also disadvantageously decreases the vehicles handling abilities and fuel efficiency.

One disadvantage of conventional brake systems is that heat generation, the mechanism by which the kinetic energy of the moving car is dissipated, has an adverse effect on the braking system's effectiveness and reliability. As the brake system continues to generate heat through multiple applications, the ability of the brake system to stop the car is decreased. The increase in stopping distance with multiple braking applications is commonly referred to as “brake fade”.

### SUMMARY OF THE INVENTION

In one embodiment, a brake system is provided, in which the braking surfaces are positioned along an interior surface of the rim portion of at least one wheel. In one embodiment, the inventive brake system integrates at least one of the functions of the wheel, brake and the suspension taking advantage of at least one of aluminum's low weight, high thermal capacity, and high conductivity in dissipating heat while stopping the vehicle.

In one embodiment, the braking system includes:
a suspension component housing an least one actuation piston to reversibly extend a brake pad; and
a wheel that is in rotational engagement to the suspension component, the wheel having a rim portion with an interior surface that is contacted by the brake pad of at least one actuation piston when in an extended position.

A wheel means a structure to which a tire is mounted. In one embodiment, the suspension component may be a structure to which the wheel is connected, and may be referred to as a knuckle, which may be cast or forged of an aluminum alloy, or may be composed of a non-ferrous metal, or may be composed of a ferrous metal, such as steel. The term rotational engagement means that the wheel is connected to a suspension component and rotates about a fixed axis. In one embodiment, the rotational engagement is provided by a wheel bearing. The terms “reversibly extend a brake pad” means that the brake pads may be extended to apply a force to the rim portion of the wheel to decelerate the vehicle, and may be disengaged from the rim portion of the wheel to remove the force in conditions under which deceleration of the vehicle is not desired. The actuation pistons extend the brake pads into contact with the rim portion of the wheel to apply braking force, and retract the brake pads from contacting the rim portion of the wheel when braking force is not desired. The term “suspension component housing at least one actuation piston” means that the actuation piston is integrated with the suspension component. In one embodiment, the integration of the actuation piston to the suspension component is provided by casting, forging, or forming a sleeve into the suspension component to house the piston assembly. In another embodiment, the integration of the actuation piston to the suspension component is provided by mechanically connecting an actuation piston assembly to the suspension component.

The term “rim portion” of the wheel denotes the portion of the wheel to which the tire is mounted, and may include an inboard bead seat and an outboard bead seat for sealing the wheel and substantially defining the rim portion width. The sealing surface of the rim portion that provides for the sealed engagement to the tire and includes the inboard bead seat, outboard bead seat, and the width of the rim portion between the inboard and outboard bead seats. The “interior surface” of the rim portion is defined as the face of the width portion of the rim portion of the wheel that is opposite the face of the sealing surface of the rim providing the sealed engagement to the tire in conjunction with the inboard and the outboard tire bead seats. The center portion of the wheel (hereafter referred to as a wheel disk) provides for connection of the wheel to the wheel bearing. The exterior face of the wheel disk is visible when installed to the vehicle. In one embodiment, the interior surface of the rim that the brake pads contact in their extended position is behind the exterior face of the disk.

In another embodiment, the inventive braking system includes:
a brake surface disposed along at least a portion of an interior surface of a rim portion of a wheel; and
a suspension component housing at least one extendable brake pad, wherein the brake pad frictionally engages said friction surface when in an extended position.

The term “brake surface” denotes a portion of the inner surface of the rim portion having a higher coefficient of friction when contacted by the brake material of the brake pad than produced by contact of the brake material to a cast, forged or machined surface of an aluminum alloy. The coefficient of friction means a measurement of the amount of friction developed between the brake pad and brake surface that are in physical contact when one of the objects is drawn across the other. The coefficient of friction may be measured using one of, but not limited to, the following methods including flat block pressed against a OD of rotating ring (FOR), flat block against another flat block (FOF), flat block sliding down an inclined runway (IS), pin pressed against a OD of rotating ring (POR), and reciprocating loaded spherical end pin pressed on a flat surface (RSOF). In one embodiment, the coefficient of friction may be measured in accordance with ASTM G115 titled “Standard Guide for Measuring and Reporting Friction Coefficients”, ASTM G133 titled “Standard Test Method for Linearly Reciprocating Ball-on-Flat Sliding Wear” or ASTM G99 titled “Standard Test Method for Wear Testing with a Pin-on-Disk Apparatus”.

The term “brake surface” denotes that when in contact to the brake pad the combination provides a coefficient of friction on the order of about 0.20 or greater, as measured in accordance with Federal Motor Vehicle Safety Standard (FMVSS) 105. For example, in one embodiment, the brake surface when in contact to the brake pad material provides a coefficient of friction on the order of about 0.25 to about 0.35, as measured in accordance FMVSS 105. In another embodiment, the brake surface when in contact to the brake pad material provides a coefficient of friction on the order of about 0.4 or greater, as measured in accordance with FMVSS 105. In a further embodiment, the coefficient of friction provided by the combination of the brake pad and the brake surface provides or exceeds the level of coefficient of friction provided by the combination of cast iron and brake material.

In one embodiment, the coefficient of friction provided by a thermally sprayed brake surface increases with increasing brake pressure. For example, as measured in accordance FMVSS 105, a thermal sprayed brake surface composed of an Aluminum/Stainless steel blend, such as a 50/50 volume % blend of Aluminum Association 1100 and AISI 308 Stainless Steel, provides a coefficient of friction ranging from approximately 0.25 and increases to approximately 0.35 with an increase in the pressure applied to the brake surface by the brake pads within a range from approximately 10 bar to approximately 100 bar.

In one embodiment the brake surface may be disposed on at least a portion of the interior surface of the rim portion of a wheel composed of aluminum. In one embodiment the brake surface may be provided by a friction-wear coating having at least one of good resistance to wear, good high temperature stability and thermal conductivity, good adhesion to aluminum, good machinability and solution potentials and coefficients of thermal expansion close to that of the aluminum substrate onto which the coating will be applied. In one embodiment, the brake surface may be provided by a friction wear coating composed of a blend of aluminum and stainless steel. In one embodiment, the friction-wear coating may be composed of a blend of Aluminum Association 1100 wrought alloy and AISI 308 stainless steel. In one embodiment, the brake surface may be composed of a ceramic or carbide or organic metallic composites.

In one embodiment, the friction surface may be in the form of a friction ring disposed along an interior surface of the rim portion of the wheel. The friction ring may be mechanically or adhesively attached to the wheel's rim portion.

In another aspect of the present invention, a method is provided for braking a vehicle. The inventive method of braking a vehicle includes the steps of:
providing a wheel comprising a brake surface disposed along at least a portion of an interior surface of the rim portion of a wheel;
providing at least one brake pad extendably mounted to a suspension component of a vehicle; and
contacting the at least one brake pad to the brake surface.

### BRIEF DESCRIPTION OF THE DRAWINGS

A more complete appreciation of the present invention and many of the attendant advantages thereof will be readily understood by reference to the following description was considered in connection with the accompanying drawings in which:

FIGS. 1a and 1b depict prospective views of one embodiment of a brake and suspension system in which the inner surface of the wheel functions as a brake surface.

FIG. 2 depicts a cross sectional view of one embodiment of a wheel having a rim portion and a center portion.

FIG. 3a depicts a side view of one embodiment of a brake and suspension system in which the inner surface of the wheel functions as a brake surface and the brake pads are actuated by two pistons connected to a suspension component.

FIG. 3b depicts a side view of another embodiment of a brake and suspension system in which the inner surface of the wheel functions as a brake surface and the brake pads are actuated by two pistons connected to a suspension component.

FIG. 3c depicts a side view of one embodiment of a brake and suspension system in which the inner surface of the wheel functions as a brake surface and the brake pads are actuated by three pistons connected to a suspension component.

FIG. 4 depicts a side view of one embodiment of a thermal spray apparatus.

FIG. 5 depicts a prospective view of one embodiment of a brake and suspension system, in which the wheel includes a brake surface ring disposed along the inner surface of the wheel's rim portion.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various embodiments and features thereof.

### DETAILED DESCRIPTION OF PREFERRED EMBODIMENTS

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention. In the accompanying drawings, like and/or corresponding elements are referred to by like reference numbers.

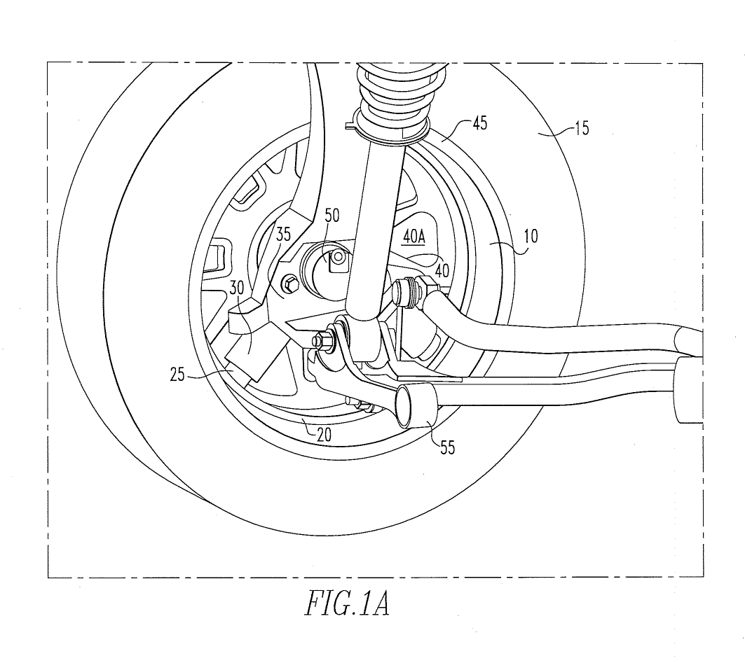

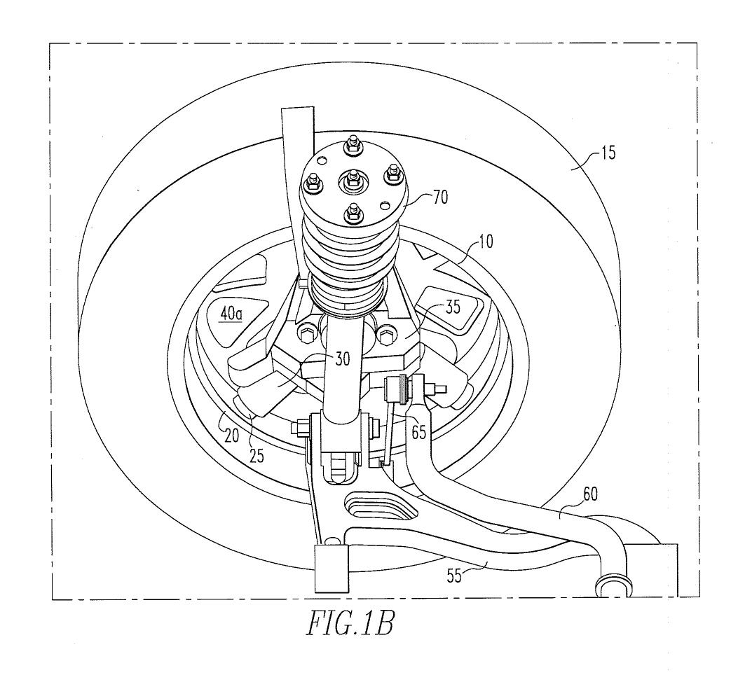

Referring to FIGS. 1a and 1b, a brake and suspension system is provided comprising a wheel 10 with a sealing surface having provisions for mounting a tire 15 and an interior surface 20 for engagement of a brake pad in decelerating a vehicle, and in one embodiment includes a braking surface that is formed into the interior surface of the rim, and in another embodiment includes a braking surface that is deposited to the interior surface of the rim, and in another embodiment includes a braking surface that is mechanically attached to the interior surface of the rim. In one embodiment, at least one brake pad 25 and actuation piston 30 is positioned mounted to at least a portion of a suspension component 35 of the vehicle, wherein the brake pad 25 may be positioned to extendably engage and/or disengage in frictional contact to the braking surface 20 disposed along the wheel's inner surface.

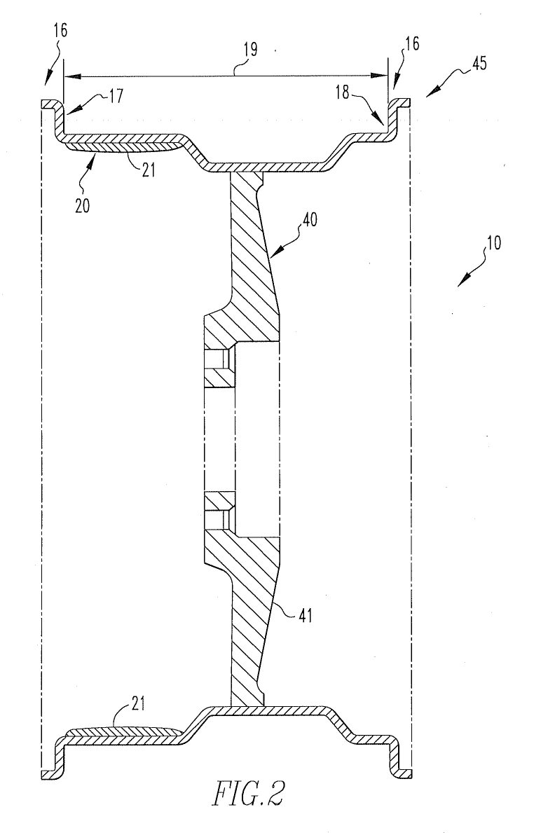

Referring to FIGS. 1a, 1b, and 2, the wheel 10 includes a center portion 40 and a rim portion 45, and in one embodiment is composed of an aluminum alloy, an in another embodiment is composed of a aluminum like material capable of sufficiently dissipating heat. The sealing surface 16 of the rim portion 45 that provides for the sealed engagement to the tire 15 includes the inboard bead seat 17, outboard bead seat 18, and the width 19 of the rim portion between the inboard and outboard bead seats 17, 18. The interior surface 20 of the rim portion 45 is the face of the width portion of the rim portion of the wheel that is opposite the face of the sealing surface 16 of the rim 45 that provides the sealed engagement to the tire in conjunction with the inboard and the outboard tire bead seats 17, 18. The wheel disk portion 40 of the wheel (also referred to as a center portion of the wheel) provides for connection of the wheel to the wheel bearing. The exterior face 41 of the wheel disk 40 is visible when installed to the vehicle. In one embodiment, the interior surface 20 of the rim contacted by the brake pads when in the extended position is behind the exterior face of the disk.

In one embodiment, the wheel disk portion 40 of the wheel 10 may include as least one cooling opening 40a, such as a cooling vent, wherein the cooling opening may be integrated into a stylized design. In one embodiment, the aluminum wheel construction and cooling openings work to dissipate heat generated during braking to reduce brake fade. In one embodiment, the aluminum wheel 10 absorbs thermal transients produced by engagement of the brake pad 25 and to the interior surface 20 of the rim portion 45 of the wheel 10, and in one embodiment to a brake surface 21, and the cooling means is configured to direct air flow across the brake surface 21 and brake pads 25.

In one embodiment, the wheel 10 may be cast of an Aluminum Association 3XX series casting alloy, such as Aluminum Association 356. Aluminum Association 356 typically includes about 6.5 wt. % to about 7.5 wt. % Si, less than about 0.6 wt. % Fe, less than about 0.25 wt. % Cu, less than 0.35 wt. % Mn, about 0.20 wt. % to about 0.45 wt. % Mg, less than 0.35 wt. % Zn and less than 0.25 wt. % Ti, and may include incidental impurities. The term “incidental impurities” denotes any contamination of the melt, including leaching of elements from the casting apparatus. Allowable ranges of impurities are less than 0.05 wt % for each impurity constituent and 0.15 wt % for total impurity content. In another embodiment, the wheel may be forged from Aluminum Association 6XXX wrought alloy, such as Aluminum Association 6061. Aluminum Association 6061 typically includes about 0.4 wt. % to about 0.8 wt. % Si, less than 0.7 wt. % Fe, about 0.15 wt. % to about 0.40 wt. % Cu, less than 0.15 wt. % Mn, about 0.8 wt. % to about 1.2 wt. % Mg, about 0.04 wt. % to about 0.35 wt. %, less than 0.25 wt. % Zn, and less than 0.15 wt. % Ti, wherein incidental impurities are limited to 0.05 wt. % individually and are limited to 0.15 wt. % in total.

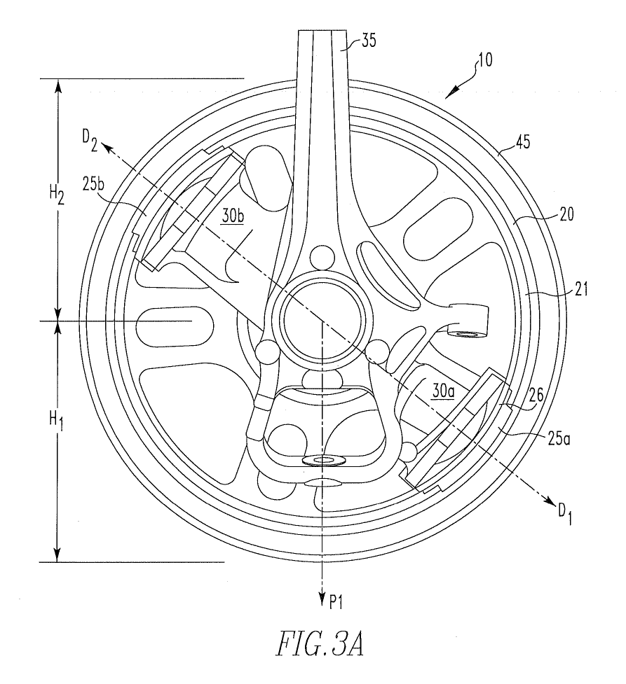

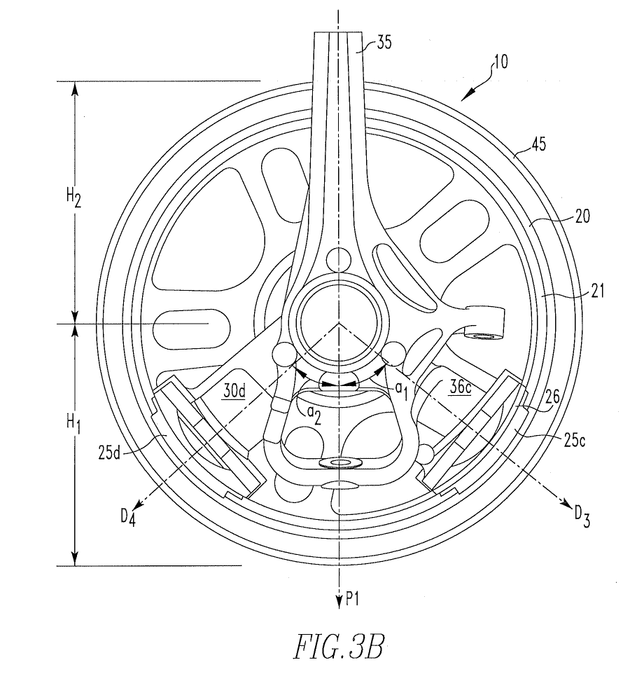

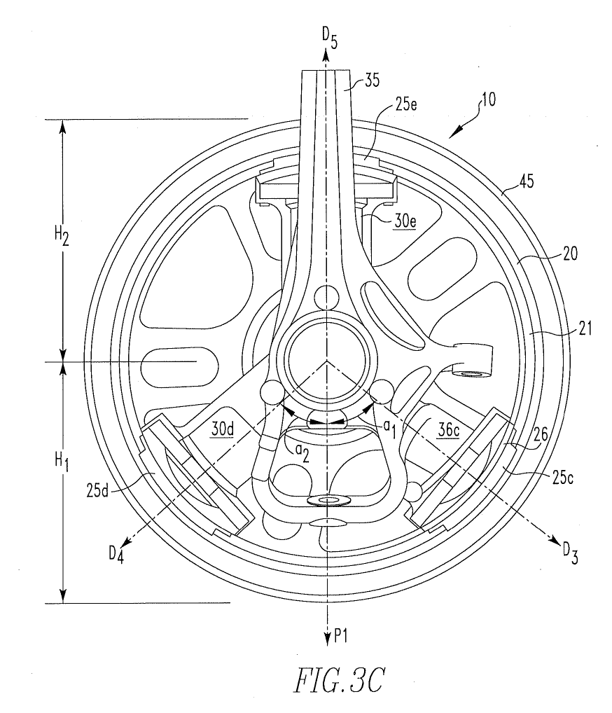

Referring to FIGS. 3a-3c, in one embodiment, a brake surface 21 may be formed on at least a portion of the interior surface 20 of the rim portion 45 of the wheel 10. In one embodiment, the brake surface 21 is provided by a friction wear coating that is thermally sprayed onto the interior surface 20 of the rim portion 45 of the wheel 10. In one embodiment, the friction wear coating may have a high temperature stability to resist melting and subsequent brake fade. In one embodiment, the friction wear coating has a thermal conductivity that transfers frictional heat from the friction wear coating to the aluminum wheel. In one embodiment, the friction wear coating provides at least one of an adhesion to aluminum and a coefficient of thermal expansion so close to that of aluminum as to prevent bond failure during braking due to thermal shock. In one embodiment, the friction wear coating solution potential is close to that of the aluminum substrate in order to prevent galvanic corrosion there between.

In one embodiment, the friction wear coating may have a thicknesses ranging from about 0.010 to about 0.200 inches. In one embodiment, the friction wear coating has a thickness on the order of about 0.25 inches. In another embodiment, the thickness of the friction wear coating may range from about 0.030 to about 0.090 inches. In one embodiment, the friction wear coating has a thickness on the order of about 0.45 inches. In one embodiment, the thickness of the friction wear coating is selected to allow for machining of the friction wear coating in providing a balanced wheel 10. It is further noted that other thickness ranges have been contemplated for the friction wear coating, wherein in some embodiments the thickness of the friction wear coating is selected depending on the intended service life of the wheel.

In one embodiment, the friction-wear coating composition may be an aluminum/stainless steel blend. In one embodiment, the aluminum component of the aluminum/stainless steel blend of the friction-wear coating is a high purity aluminum alloy, such as Aluminum Association 1100. The term “high purity aluminum alloy” means that the minimum aluminum content is about 99% or greater. Aluminum Association 1100 may be an aluminum alloy composed of about 0.05 wt. % to about 0.20 wt. % Cu, less than 0.05 wt. % Mn, and less than 0.10 wt. % Zn, wherein incidental impurities may not exceed greater than about 0.05 wt. % individually or 0.15 wt. % in total. In another embodiment, the aluminum component of the aluminum/stainless steel blend may include at least one of Aluminum Association 2319 or Aluminum Association 4043. In another embodiment, the aluminum component of the aluminum/stainless steel blend includes hypereutectic Al—Si alloy, such as Aluminum Silicon Carbide.

In one embodiment, the stainless steel (chromium-nickel steel) component of the aluminum/stainless steel blend is a 300 series stainless steel, such as AISI 308 stainless steel. In one embodiment, 308 stainless steel typically includes about 19.0 wt. % to about 21.0 wt. % Cr, about 10.0 wt. % to about 12.0 wt. % Ni, less than about 2.0 wt. % Mn, less than about 1.0 wt. % Si, less than about 0.08 wt. % C, less than about 0.045 wt. % P, and less than about 0.03 wt. % S.

In one embodiment, the aluminum and stainless steel constituents of the aluminum/stainless steel blend are applied as a 50/50 (by volume) mixture of each constituent. It is noted that other ratios have been contemplated and are within the scope of the present invention, wherein the volume % of the aluminum and stainless steel components may be varied to correspond to the braking performance and service life of a given vehicle. In one embodiment, increasing the stainless steel content of the aluminum/stainless steel blend increases the service life of the friction wear coating. In one embodiment, increasing the aluminum content of the aluminum/stainless steel blend increases adhesion of the friction wear coating to the wheel.

In one embodiment, the friction wear coating is formed on the interior surface 20 of the rim portion 45 of the wheel 10 using thermal arc spray. In other embodiments, the friction wear coating deposition process includes, but is not limited too, detonation thermal spray, high velocity oxygen fuel (HVOF) thermal spray, high velocity combustion thermal spay, low velocity combustion thermal spray, plasma thermal spray, plasma transferred arc spray, twin wire arc thermal spray, cold gas spray technology, kinetic spray, kinetic metallization, anodizing and electrostatic spray.

In one embodiment, prior to deposition of the friction wear coating, the wheel 10 is heated to substantially minimize crack formation that may result from thermally induced stresses produced by differences in the coefficients of expansion between the wheel 10 and the friction wear coating. In another embodiment, heating the wheel 10 prior to deposition of the friction wear coating by thermal spray produces a friction wear coating in a compressive state upon cooling of the wheel 10, wherein the friction wear coating may provide a brake surface 21, and has a lower coefficient of thermal expansion than the wheel 10.

In one embodiment, prior to deposition of the friction wear coating the wheel 10 is heated to a temperature between about 200° F. to about 1000° F. In another embodiment, prior to the deposition of the friction wear coating, the wheel 10 is heated to a temperature of about 400° F. to about 800° F. In yet another embodiment, prior to the deposition of the friction wear coating, the wheel 10 is heated to a temperature within the range of about 500° F. to about 700° F.

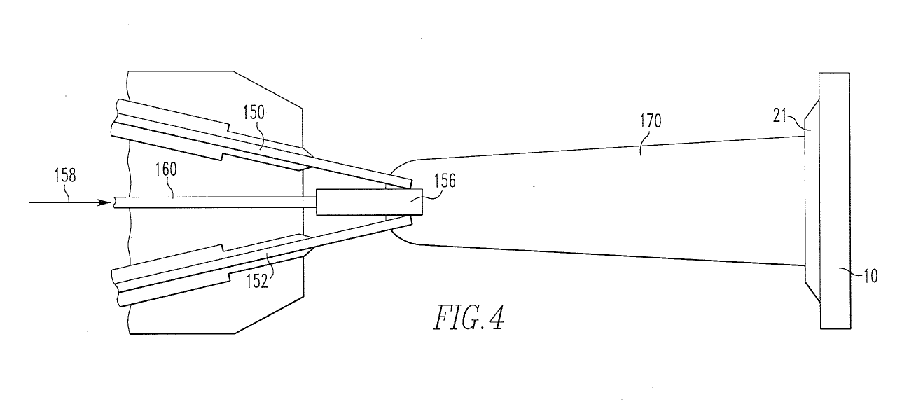

In one embodiment, following heating of the wheel 10, the friction wear coating is thermally arc-sprayed onto at least a portion of the wheel, such as the interior surface 20 of the rim portion 45 of the wheel 10, to produce the brake surface 21. Referring to FIG. 4, in one embodiment, thermal arc-spraying may comprise the continuous feeding of at least two separate wires 150 and 152 of about the same or of differing compositions into an atomizing nozzle 156 supplied with a jet of gas 158 through passageway 160. The at least two wire feeds are held at different electric potentials so that an electric arc generates between them. In one embodiment, the wires 150 and 152 are consumable electrodes that melt continuously during the application process. The jets of gas 158, in one embodiment provided by compressed air, then atomizes these molten materials and accelerates their molten droplets in a spray stream 170 for deposition onto the wheel 10 to create the friction wear coating, wherein in one embodiment provides the brake surface 21.

It will be appreciated that in one embodiment of this invention, the wires 150 and 152 include a 50/50 by volume mixture of aluminum, such as high purity aluminum, including but not limited to Aluminum Association 1100 alloy, and stainless steel, including but not limited to 308 stainless steel. The types of wire and relative proportions of components may be changed within the spirit of this invention. In another embodiment, the thickness of feed wires and/or feed rates are varied to impact different relative compositions onto a substrate, aluminum or otherwise. In another embodiment, a single braided wire, composed of a first metal strand (e.g., aluminum alloy 1100) and an intertwining second metal strand (eg., 308 stainless steel) may also be used to deposit coatings onto the inner surface of the wheel. In another embodiment, a single wire having a first metal inler core (e.g., aluminum alloy 1100) clad with a coating of second metal (such as 308 stainless steel) can be used.

In one embodiment, the inner surface of the wheel may be prepared prior to deposition of the friction wear coating to reduce the incidence of delamination by thermal shock mechanisms. For example, in one embodiment, delamination of the friction wear coating may be substantially reduced by providing a series of surface roughenings or grooves, to the wheel surface before a coating is thermally sprayed thereon. In one embodiment, the grooves or rouphenings are machined into the inner surface 20 of the rim portion 45 of the wheel 10, before applying the friction wear coating. In another embodiment, the grooves or roughening of the surface may be cast, arc textured, or even chemically etched into the interior surface 20 of the rim portion 45 of the wheel 20. In one embodiment, at least a portion of the interior surface 20 of the rim portion of the wheel may be tapered, whereas the diameter increase in the inboard direction of the wheel 10 from the wheel's exterior surface, wherein the brake pads 25 may contact the tapered portion of the interior surface 20.

In another embodiment, the brake surface 22 may comprises any hard wear resistant material, such as a ceramic, carbide or organic metallic composite. In one embodiment, the brake surface may comprise aluminum oxide. In one embodiment the brake surface 22 may be a cermet material. Cermets that are suitable for providing the brake surface 22 include composites composed of ceramic and metallic materials. The ceramic material may include an oxide, boride, carbide, alumina or combination thereof. The metallic is used as a binder for an oxide, boride, carbide, or alumina. In one embodiment, the metallic elements used are nickel, chrome, molybdenum, and cobalt. The cermets may also be metal matrix composites, but are typically less than 20% metal by volume. Preferred cermets include tungsten carbide and chrome carbide with a cobalt binder and tungsten carbide with a nickel binder.

The brake surface 22 may be applied to the inner surface of the rim 45 using deposition techniques including, but not limited too: plasma spray, flame spray, electroplating or like deposition processes and combinations thereof. In some embodiments, the brake surface 22 may be formed or embedded into the wheel's 10 rim portion 45. Regardless of the forming or embedding technique, the wheel 10 in its final form, including the brake surface 22, must be balanced. In order to achieve a rotational balance, the brake surface 22 may be trued by machining, grinding or polishing.

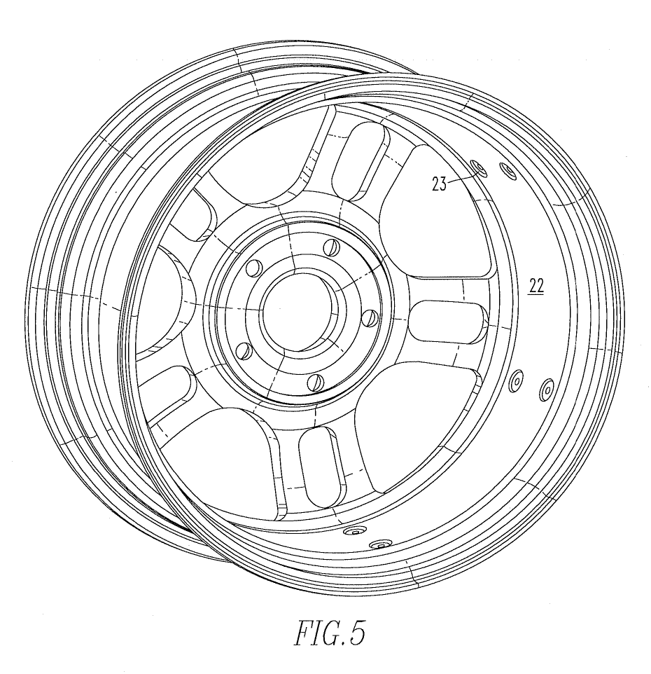

Referring to FIG. 5, in another embodiment, the braking surface may be provided by a brake ring 22 disposed along an inner surface 20 of the rim portion 45 of the wheel 10. In one embodiment, the brake ring 22 is an annular ring having an outside diameter to provide an exterior surface for engagement to the interior surface of the rim portion of the wheel. In one embodiment, the brake ring 22 may be composed of an aluminum alloy, such as Aluminum Association 356, in which the interior surface of the brake ring 22 provides the surface for a friction wear coating that may be deposited by thermal spray.

Referring to FIG. 5, in another embodiment, the brake ring 22 may by composed of any hard wear resistant frictional material, such as a ceramic, carbide or organic metallic composites. The brake ring 22 may be welded, mechanically attached or adhesively attached to the wheel's rim portion 45. In one example, the brake ring 22 may mechanically attached by fasteners 23 that may be disengaged for replacement of the brake ring 22. In one embodiment, the brake ring 22 may be adhesively attached to the interior surface of the rim. In another embodiment, mechanical fasteners or interlocking surfaces provides engagement between the brake ring 22 and the interior surface of the rim portion of the wheel and may further the integrity of an adhesive engagement. It is noted that any attachment means, may be utilized to connect the brake ring 21 to the wheel structure 10, so long as the wheel 10 may be rotationally balanced.

Referring to FIGS. 3a-3c, the brake system further includes at least one brake pad 25 and actuation piston 30a, 30b, 30c positioned to provide that the brake pad 25 may be extended into frictional contact with the interior surface 20 of the rim portion 45. In one embodiment, the interior surface 20 of the rim portion 45 of the wheel 10 further includes a brake surface 21, that in one embodiment may be provided by a friction wear coating. In one embodiment, the interior surface 20 of the rim portion 45 of the wheel 10 further includes a brake ring 22. The actuation piston 30 may be integrated into a suspension component 35. In one embodiment the actuation piston 30 may be integrated into a knuckle. The actuation piston 30 may include pneumatic, electro-servo, electro-magnetic or hydraulically extendable cylinders, preferably being hydraulically extendable cylinders. Although the following description refers to the embodiments depicted FIGS. 3a-3c, in which the wheel incorporates a brake surface 21 formed on the interior surface 20 of the rim portion 45 of the wheel 10, the description relating to the number and orientation of the actuating pistons and brake pads is equally applicable to the full range of embodiments described throughout the present disclosure.

In one embodiment, the number of actuation pistons 30 and brake pads 25, as well as, the positioning of the points at which the brake pads 25 contact the rim portion 45 of the wheel 10 may be varied depending upon the degree of wheel deflection and the force experienced by the wheel bearing. Wheel deflection is a dimensional change in the wheel's diameter that may results from the force applied by the brake pad 25 and actuation piston 30 to the rim portion 45 of the wheel 10. The force experienced by the wheel bearing is the force that is measured at the bearing connecting the wheel 10 to the suspension component 35 resulting from the force applied to the rim portion 45 by the application of the break pads 25.

Referring to FIG. 3a, in one embodiment, two pistons 30a, 30b are oriented in opposing directions, wherein each actuation piston 30a, 30b is housed in the suspension component 35, such as a knuckle. In one embodiment, a first piston 30a having a housing that is formed within the suspension component 35 extends the corresponding brake pad 25a in a first direction D1 into friction contact with the brake surface 21, and a second piston 30b having a housing also formed within the suspension component 35 extends the corresponding brake pad 25b in a second direction D2, wherein the first direction D1 is opposite to the second direction D2. In one embodiment, the first actuation piston 30a is positioned to contact the brake surface 21 on at least a portion of the lower half H1 of the wheel 10, and the second actuation piston 30b is positioned to contact the brake surface 21 on at least a portion of the upper half H2 of the wheel 10.

In one embodiment, orientating the actuation pistons 30a, 30b to extend the brake pads 25a, 25b in opposite directions D1, D2 results in a minimized load being transferred to the wheel bearing, wherein the wheel bearing connects the wheel 20 to the suspension component 35. The minimized load measured at the wheel bearing partially results from a substantially equal force being applied from each brake pad 25a, 25b in opposing directions D1, D2, wherein the wheel bearing is positioned directly between the opposing brake pads 25a, 25b. In this configuration the force attributed to the wheel bearing by the first brake pad 25a is substantially equalized by the opposing second brake pad 25b.

Referring to FIG. 3b, in another embodiment, two pistons 30c, 30d are housed in a suspension component 35, such as a knuckle, wherein each of the pistons 30c, 30d are orientated to extend each of the brake pads 25c, 25d into contact with the rim portion 45 at a portion of the lower half of the wheel 10. In one embodiment, orientating both of the pistons 30c, 30d to extend the brake pads 25c, 25d to contact the rim portion 45 of the wheel 10 at the lower half of the wheel 10 reduces the degree of wheel deflection, in comparison to the embodiment depicted in FIG. 3a. In one embodiment, each actuation piston 30c, 30d extends a piston 25c, 25d along a direction D4, D3 that forms an angle α1, α2 of about 50 degrees from the plane P1 going through the center of the wheel and being perpendicular to the road. In one embodiment, the lower degree of wheel deflection may result from the force applied by the actuation pistons 30c, 30d and brake pads 25c, 25d to the rim portion 45 of the wheel 10 being substantially equalized by opposing forces resulting from the contact of the tire to the ground.

Referring to FIG. 3c, in one embodiment, three actuating pistons 30c, 30d, 30e are housed in the suspension component 35 and orientated to extend three brake pads 25c, 25d, 25e into contact with a friction surface 21 on the rim portion 45 of the wheel 10. In one embodiment, two of the pistons 30c, 30d are orientated to extend each of the brake pads 25c, 25d into contact with the rim portion 40 of the wheel 10 at a portion of the lower half H1 of the wheel 10, and the third piston 30e is orientated to extend the third brake pad 25e into contact the rim portion 45 of the wheel 10 at a portion of the upper half H2 of the wheel 10.

In one embodiment, wheel deflection is minimized by orientating the first and second brake actuation pistons 30c, 30d to extend the brake pads 25c, 25d and the majority of the braking force into contact with the rim portion 45 of the lower half H1 of the wheel 10, wherein the deformation to the rim portion 45 resulting from force applied by the brake pads 25c, 25d is substantially equalized by opposing forces produced by the contact of the tire to the ground. In one embodiment, the third piston 30e is orientated to extend a third brake pad 25e into contact with a portion of the rim portion 45 of the wheel 10 in the upper half H2 of the wheel 10, wherein the force applied to the rim portion 45 on the upper half H2 of the wheel 10 compensates for the force applied to the lower half H1 of the wheel 10 in reducing the force applied to the wheel bearing, when compared to the embodiment depicted in FIG. 3b.

Referring to FIG. 3c, in one embodiment, two of the actuating pistons 30c, 30d are orientated to extend a piston 25c, 25d along a direction D4, D3 that forms an angle al, a2 of about 50 degrees from the plane P1 going through the center of the wheel 10 and being perpendicular to the road, and the third actuating piston 30e is orientated to extend the brake pad 25e along the plane P1 going through the center of the wheel and being perpendicular to the road, and into contact with a portion of the rim 45 along a direction D5 that is opposite the portion of the rim 45 corresponding to the portion of the tire that is contacting the ground.

In one embodiment, the suspension component 35 may be cast using permanent mold casting technology, sand casting technology, or a Vacuum Riserless Casting (VRC)/Pressure Riserless Casting (PRC). The Vacuum Riserless Casting (VRC)/Pressure Riserless Casting (PRC) process is suitable for mass production of aluminum automotive suspension components. VRC/PRC is a low pressure casting process, in which in some embodiments the pressure may be on the order of 6.0 Psi. In VRC/PRC, a mold is positioned over a hermetically sealed furnace and the casting cavity is connected to the melt by feed tubes. Melt is drawn into the mold cavity by applying a pressure to the furnace through the application of an inert gas, such as Ar. A constant melt level is maintained in the furnace of the VRC/PRC apparatus, avoiding back-surges that are sometimes experienced in the more traditional low pressure system. Multiple fill tubes (stalks) provide for metal distribution in the mold cavity. Multiple fill points combined with close coupling between the mold and melt surface allows lower metal temperatures, minimizes hydrogen and oxide contamination and provides maximum feeding of shrinkage-prone areas in the casting. The multiple fill tubes also allow multiple yet independent cavities in a mold. Sequenced thermal controls solidify castings from extreme back to fill tubes, which then function as feed risers. It has been contemplated that the suspension component be a hollow casting. Although, it is highly preferred that the suspension component 10 be cast, it has been contemplated that the suspension component be formed, i.e. forged.

Referring to FIGS. 1a and 1b, in one embodiment, in addition to providing the integration point for the brake pads 25 and actuating piston 30, the knuckle further comprises a means to provide rotational engagement with the wheel 10. In one embodiment, the actuation pistons may be in the form of a subassembly that is attached to the knuckle 35, wherein attachment may be achieved mechanically. In one embodiment, the knuckle 35 comprises aluminum and may further comprise hydraulic and/or electrical pathways in communication to the actuation means of at least one brake pad. In one embodiment the knuckle may be cast ferrous metal.

In one embodiment, the knuckle may include a sensor 50 housed within the knuckle, wherein the sensor 50 is configured to determine the rotation speed of the wheel 10. Preferably, the sensor is a component of an anti-lock brake system, wherein the anti-lock system further comprises at least one valve positioned along the hydraulic pathways of the knuckle.

The knuckle may further comprises attachment points for further suspension means, including but not limited to: control arms, sway bars, sway bar end links, coil springs, transverse springs, shocks, strits, coil-over shocks, wheel bearings, camber rods, trailing arms, ball joints, toe rods, and tie-rods.

The brake pads 25 may be composed of any braking material (also referred to as brake lining) used in transport applications, including but not limited to: semi-metallic brake materials, ceramic brake materials, or organic brake material. The brake pads further include a back plate 26 that may be composed of a steel plate to which braking material is molded or riveted to produce a disc brake pad.

While a number of embodiments of the present invention have been described, it is understood that these embodiments are illustrative only, and not restrictive, and that many modifications may become apparent to those of ordinary skill in the art.

What is claimed is:

1. A braking system comprising:
a suspension component housing at least one actuation piston to reversibly extend a brake pad; and
a wheel that is in rotational engagement to the suspension component, the wheel having a rim portion with an interior surface that is contacted by the brake pad of at least one actuation piston when in an extended position.

2. The braking system of claim 1, wherein said at least one actuation piston further comprises two actuation pistons, a first of the two actuation pistons extending a first brake pad along a first direction into contact with the interior surface of the rim portion of the wheel on a lower half of the wheel, and a second of the two actuation pistons extending a second brake pad along a second direction into contact with the interior surface of the rim portion of the wheel on an upper half of the wheel.

3. The braking system of claim 2, wherein the first direction opposes the second direction.

4. The braking system of claim 1, wherein said at least one actuation piston further comprises two actuation pistons, wherein each of the two actuation pistons extend their corresponding brake pad to contact the interior surface of the rim portion of the wheel on a lower half of the wheel.

5. The braking system of claim 1, wherein the at least one actuation piston further comprises three actuation pistons, wherein a first and second actuation piston of the three actuation pistons extend their corresponding first and second brake pad to contact the interior surface of the rim portion of the wheel on a lower half of the wheel, and the third actuation piston extends a third brake pad to contact the interior surface of the rim portion of the wheel on the upper half of the wheel.

6. A braking system comprising:
a brake surface disposed along an interior surface of a wheel; and
a suspension component housing at least one extendable brake pad, wherein the brake pad engages the friction surface when in an extended position.

7. The brake system of claim 6, wherein the interior surface of the wheel is a rim portion.

8. The brake system of claim 6, wherein the brake surface comprises a friction wear coating comprising aluminum and stainless steel.

9. The brake system of claim 7, wherein the brake surface disposed along the interior surface of the rim portion of the wheel comprises a ceramic, carbide or organic metallic composite.

10. The brake system of claim 6, wherein the brake surface disposed along the interior surface of the rim portion of the wheel comprises a brake ring.

11. The brake system of claim 10, wherein the brake ring is mechanically or adhesively attached to the wheel.

12. The brake system of claim 11, wherein the brake ring comprises an aluminum substrate and a friction wear coating.

13. The brake system of claim 6, wherein the wheel comprises aluminum.

14. The brake system of claim 6, wherein the suspension component is a knuckle comprising aluminum.

15. The brake system of claim 14 said knuckle further comprising hydraulic pathways in communication with said at least one brake pad.

16. The brake system of claim 15, wherein said knuckle further comprises attachment points for at least one of the group consisting of control arms, sway bars, sway bar end links, coil springs, transverse springs, shocks, struts, coil-over shocks, wheel bearings, camber rods, trailing arms, ball joints, toe rods, and tie-rods.

17. A method of braking a vehicle comprising:
providing a wheel comprising a brake surface disposed along at least a portion of the interior surface of the wheel;
providing at least one brake pad extendably mounted to a suspension component of a vehicle; and
contacting the at least one brake pad to the frictional surface.

18. The method of claim 17, further comprising coating the brake surface to the interior surface of a rim portion of the wheel.

19. The method of claim 18, wherein the coating of the brake surface to the interior surface of the rim portion of the wheel comprises detonation thermal spray, high velocity oxygen fuel (HVOF) thermal spray, high velocity combustion thermal spay, low velocity combustion thermal spray, plasma thermal spray, plasma transferred arc spray, thermal arc spray, twin wire arc thermal spray, cold gas spray technology, kinetic spray, kinetic metallization, anodizing, electrostatic spray or a combination thereof.

20. The method of claim 17, wherein the brake surface further comprises a mechanically attached brake ring.
